(19) United States
(12) Patent Application Publication
(10) Pub. No.: US 2019/0220829 A1
(43) Pub. Date: Jul. 18, 2019

(54) Systems and Methods of Tracking Collection and Disposal of Unsaleable Items

(71) Applicant: Waste Repurposing International, Inc., Austin, TX (US)

(72) Inventor: Christopher B. Ripley, Lichtfield, CT (US)

(73) Assignee: Waste Repurposing International, Inc., Austin, TX (US)

(21) Appl. No.: 16/248,734

(22) Filed: Jan. 15, 2019

Related U.S. Application Data
(60) Provisional application No. 62/617,493, filed on Jan. 15, 2018.

(51) Int. Cl. G06Q 10/00; G06Q 10/08; G01G 23/42

(52) U.S. Cl. CPC G06Q 10/30; G06K 7/1413; G01G 23/42; G06Q 10/0838

(57) ABSTRACT

In some embodiments, an apparatus including a network interface coupled to a network. The apparatus may further include at least one optical sensor configured to capture optical data and a processor coupled to the network interface and to the at least one optical sensor. The processor may be configured to receive optical data corresponding to an unsaleable item from the at least one optical sensor, automatically identify the unsaleable item based on the optical data, and automatically create a data record associated with the unsaleable item. The processor may be further configured to communicate the data record to at least one node coupled to the network to update a block chain representing data associated with capture and disposal of the unsaleable item.

### CROSS-REFERENCE TO RELATED APPLICATION(S)

This application is a non-provisional of and claims priority to U.S. Provisional Patent Application No. 62/617,493 filed on Jan. 15, 2018 and entitled “Mobile Waste Capture Systems and Methods”, which is incorporated herein by reference in its entirety.

### FIELD

The present disclosure is generally related to systems, methods and devices configured to collect and maintain data associated with unsaleable items; and more particularly to mobile systems for performing such operations at one or more collection sites along a scheduled route or at different physical locations within a facility.

### BACKGROUND

Generally, retailers are responsible for every product sold on their shelves and throughout the stores. When products are damaged, expired, returned, or otherwise unsaleable, such items, sometimes called “waste items”, may be handled according to particular procedures. Often retailers may track disposal of such items, for inventory purposes, for example. For items deemed hazardous to the environment, regulations may specify that the retailer maintain documentation of the handling and disposal of such items. Improper disposal can expose a retailer to fines and other consequences.

In the context of pharmaceutical items, expired, returned, or otherwise unsaleable medicinal inventory may require disposal. Typically, an employee may document the waste items (such as damaged products, expired products, returned items, pharmaceutical waste, or other waste items) by handwriting or otherwise entering information into one or more forms. Disposal of the items may be documented, and the employee may utilize the one or more forms and confirm the contents. A company may be tasked with collecting and acknowledging the contents, and may then assume responsibility for the waste product, potentially exposing the company to fines or other consequences for improper disposal.

### SUMMARY

Embodiments of systems, methods, and devices are described below which may be used in the collection and disposal of unsaleable items. In some embodiments, the systems, methods, and devices may be configured to identify the unsaleable items, to create a digital record associated with each unsaleable item at an item collection point of a collection and disposal process, and to communicate the digital record to a network of computing nodes. The nodes of the computing network may check the details of the digital record to confirm its validity. If the digital record is valid, the digital record can be added to a data block having a unique hash code (representing the source of the data contributed to the block, the date and time of the update, other information, or any combination thereof) and including a hash code of a previous data block in a block chain. Further, the systems, methods, and devices may be configured to update the digital record at each of a plurality of item handling points in the collection and disposal process, adding information to the block chain at each handling point. The block chain represents a distributed database of collection and disposal information that is very difficult (if not impossible) to alter for each of a plurality of unsaleable items. Since any change to data within the block chain creates a new unique hash code, changing existing data within the block chain breaks the chain, and would require updating each of the subsequent data blocks in the block chain, making the data harder to corrupt without creating evidence of the change. Thus, the block chain may be used to provide reliable digital documentation for audits and other purposes.

In some embodiments, an apparatus including a network interface coupled to a network. The apparatus may further include at least one optical sensor configured to capture optical data and a processor coupled to the network interface and to the at least one optical sensor. The processor may be configured to receive optical data corresponding to an unsaleable item from the at least one optical sensor, automatically identify the unsaleable item based on the optical data, and automatically create a data record associated with the unsaleable item. The processor may be further configured to communicate the data record to at least one node coupled to the network to update a block chain representing data associated with capture and disposal of the unsaleable item.

In other embodiments, a waste management system may include a network interface coupled to a network, a memory, and a processor coupled to the memory and to the network interface. The processor may be configured to receive one or more data records corresponding to one or more unsaleable items from a mobile unit through the network and to append the one or more data records as a data block to a local version of a block chain in the memory. The data block may include a hash value associated with a previous data block in the block chain and may include a unique hash value. Further, the processor may be configured to post the data block to the network to update the block chain at other nodes of the network. The block chain may represent documentation of handling of the one or more unsaleable items from collection to disposal.

In still other embodiments, a method of tracking collection and disposal of unsaleable items may include receiving data corresponding to collection of one or more unsaleable items at a processor of a device. The data may be associated with each of the one or more unsaleable items and may include optical data, item identification data, date and time data corresponding to collection of collection, an identifier associated with a user, and other data. The method may further include generating, using the processor of the device, a block of data including data associated with the one or more unsaleable items. The block of data can include a unique hash value and including a hash value of a previous block of data in a block chain. The method may further include posting the block of data to the block chain.

### BRIEF DESCRIPTION OF THE DRAWINGS

FIG. 1 depicts a block diagram of a system configured to capture data corresponding to the collection and disposal of unsaleable items, in accordance with certain embodiments of the present disclosure.

FIG. 2 depicts a block diagram of a system including the elements of FIG. 1 and depicting a distributed block chain of data related to the collection and disposal of unsaleable items, in accordance with certain embodiments of the present disclosure.

FIG. 3 depicts a block diagram of a system including a mobile unit configured to capture data corresponding to the collection and disposal of unsaleable items, in accordance with certain embodiments of the present disclosure.

FIG. 4 depicts a system including the mobile unit of FIGS. 1-3, in situ, in accordance with certain embodiments of the present disclosure.

FIG. 5 depicts a graphical login interface provided by the mobile unit of FIGS. 1-4, in accordance with certain embodiments of the present disclosure.

FIG. 6 depicts a graphical site interface provided by the mobile unit of FIGS. 1-4, in accordance with certain embodiments of the present disclosure.

FIG. 7 depicts a graphical sorting interface provided by the mobile unit of FIGS. 1-4, in accordance with certain embodiments of the present disclosure.

FIG. 8 depicts a graphical sorting interface provided by the mobile unit of FIGS. 1-4 to select and print labels for source bins, in accordance with certain embodiments of the present disclosure.

FIG. 9 depicts a graphical package management interface provided by the mobile unit of FIGS. 1-3 to select and print labels and reports, in accordance with certain embodiments of the present disclosure.

FIG. 10 depicts a graphical site checklist interface provided by the mobile unit of FIGS. 1-4 to identify tasks to be completed and verified by the operator, in accordance with certain embodiments of the present disclosure.

FIG. 11 depicts a graphical document capture interface provided by the mobile unit of FIGS. 1-4 to allow the operator to scan and upload documents, in accordance with certain embodiments of the present disclosure.

FIG. 12 depicts a flow diagram of a method of capturing waste items, in accordance with certain embodiments of the present disclosure.

FIG. 13 depicts a flow diagram of a method of updating a block chain based on captured data associated with an unsaleable item, in accordance with certain embodiments of the present disclosure.

FIG. 14 depicts a flow diagram of a method of providing data associated with the block chain to a computing device in response to a request, in accordance with certain embodiments of the present disclosure.

FIG. 15 depicts a flow diagram of a method of updating a block chain with data records related to unsaleable items, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

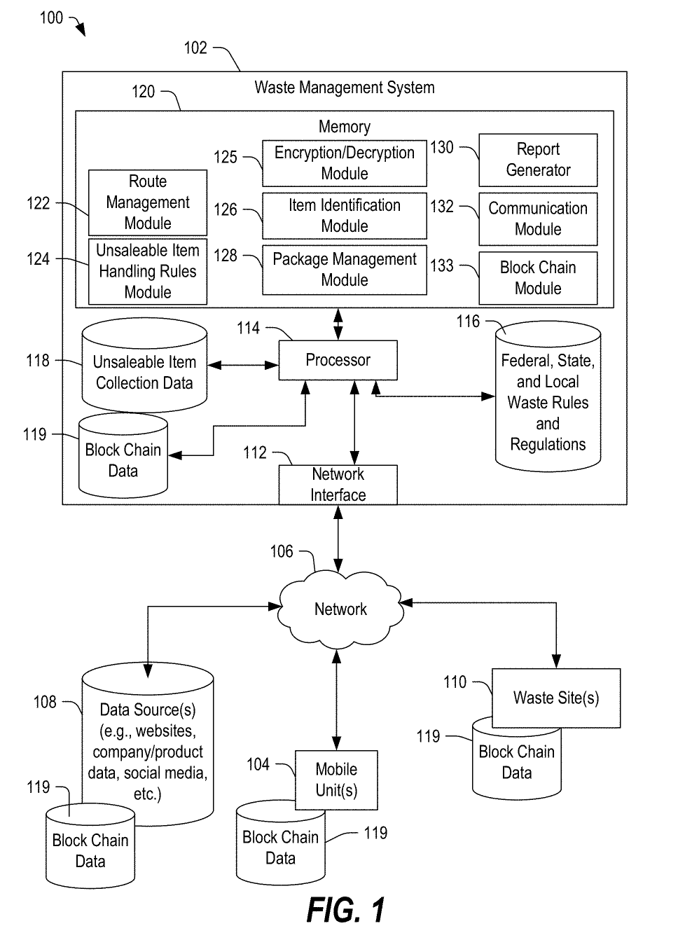

In general, speed, accuracy, and quality control are important aspects of successful collection and disposal of unsaleable items. Embodiments of systems, methods, and devices are described below with respect to FIGS. 1-14 that may be configured to provide automated mechanisms for item identification, categorization, documentation, and safe storage of unsaleable items for transport. The systems, methods, and devices can improve the speed and accuracy of the data collection process and can provide an audit trail for demonstrating proper handling and disposal of unsaleable items, which may be particularly helpful with respect to regulated items, such as household hazardous waste items, pharmaceutical items, and other regulated items. In some embodiments, the systems, methods, and devices may be configured to automate the data collection process by optically scanning each unsaleable item, automatically determining data about the items based on the optical scanning, and automatically generate a data record corresponding to the unsaleable item. In some instances, the data record may be added to a data block and appended to a block chain. The data record may include information about the item; date, time, and location data associated with the collection, handling, or disposal of the item; user information; computing device information; storage bin information; other information; or any combination thereof.

In some embodiments, the systems, methods, and devices may be configured to provide electronic reporting of the data record; automated generation of manifests for transport of one or more unsaleable items; audit trail information; and other reports. In some embodiments, the systems, methods, and devices may be configured to aggregate data records to form a data block and to append the data block to a block-chain, which may be stored across a plurality of systems and devices to provide a chain of custody and an audit trail for each unsaleable item from collection to disposal.

It should be appreciated that, in the context of retrieval of unsaleable pharmaceutical items or of unsaleable items classified as household hazardous waste (e.g., batteries, cleaning supplies, and the like), various federal, state, and municipal regulations may specify procedures for the safe handling and disposal of such items. Within a large metropolitan area, such regulations may vary from facility to facility based on its geographic location. Such variations can present complications for training collection workers, and may expose collection companies to risk if the collection and handling of such items do not comply with the regulations governing a selected facility. Embodiments of the systems, devices, and methods may adjust workflows and specify appropriate handling procedures based on the geographic position of the device at the time when the item is received (collected), automating compliance tasks and allowing for customized workflows for each facility. One possible embodiment of a system configured to capture, document, and store data related to unsaleable items is described below with respect to FIG. 1.

FIG. 1 depicts a block diagram of a system 100 configured to capture data corresponding to the collection and disposal of unsaleable items, in accordance with certain embodiments of the present disclosure. The system 100 may include a waste management system 102 configured to communicate with one or more mobile units 104, one or more data sources 108, and one or more waste sites 110 through a network 106, such as the Internet. The waste management system 102 may be configured to receive data from each of the one or more mobile units 104. The received data may include information about unsaleable items received by the mobile unit 104. In some embodiments, the received data may include a block of data records together with a signature, a hash value, and a hash value of the previous data block in the block chain. In this example, the data block may be appended to the block chain in an ordered sequence so that items collected and digitally documented (processed by a mobile unit 104) may be stored within a data block of the block chain. Subsequent handling of the item, such as pickup of the item from a retail location for transportation and optionally disposal, may cause the item (or a bin or package containing the item) to be scanned, creating a new data point for appending to the block chain. In some embodiments, items are sorted into bins or containers. When the container is ready for handing off, the weight of the container including each of the items is verified, and a manifest is produced. At a time of pickup, the manifest may be scanned again and the container weighed to confirm the contents and weight. If custody of the container changes again, the container may be rescanned and verified. Each scan and verify operation may cause the system 100 to append the block chain. As a result, the block chain may provide a chain-of-custody and documentation of each item from capture to disposal, providing a verifiable audit trail for each item.

In some embodiments, the one or more data sources 108 can include websites, databases, social media websites, company data, product data, other data sources, or any combination thereof. In some examples, at least one of the one or more data sources 108 may be part of or may be hosted by the waste management system 102. Further, in some embodiments, some of the one or more data sources 108 may include a database of block chain data 119.

The one or more waste sites 110 can include retail store locations, residential locations, hospitals, hotels, restaurants, other locations, or any combination thereof. Further, at least some of the one or more waste sites 110 can include a database of block chain data 119. Each of the one or more mobile units 104 can include a vehicle with a payload area defining an enclosure to house a mobile cart with computing system and optionally to transport packages including one or more unsaleable items. In other embodiments, each of the one or more mobile units 104 can include a cart with an attached computing device. Further, each computing device may include a database of block chain data 119. In some embodiments, the one or more mobile units 104 may include tablet computing devices. Other configurations are also possible; however, the term mobile, as used herein, refers to the ability to move the mobile unit 104 from one location to another, either manually (such as by pushing a cart) or within the payload area of a vehicle. In a tablet computer implementation, the mobile unit 104 may be carried by hand. Other embodiments are also possible.

The waste management system 102 may include a network interface 112 configured to communicate with the network 106. The waste management system 102 may further include a processor 114 coupled to the network interface 112, to a database 116 of federal, state, and local waste rules and regulations, and to a database 118 of waste collection data. Additionally, the waste management system 102 can include a database of block chain data 119, which may include one or more block chains corresponding to the capture, transport, and disposal of unsaleable items. The waste management system 102 may further include a memory 120 coupled to the processor 114. The memory 120 may be configured to store data and instructions, which may be executed by the processor 114.

The memory 120 may include route management module 122 that, when executed, may cause the processor 114 to determine selected waste sites for a particular mobile unit 104 and may cause the processor 114 to communicate the selected waste sites to the mobile unit 104. In an example, each waste site may correspond to a business or a residence that has waste items for collection. The route management module 122 may also cause the processor 114 to organize a route including the selected waste sites by putting the selected waste sites in a particular order. In some instances, the route management module 122 may select the waste sites based on a service schedule and based on waste sites that may not have been completed according to its regular service schedule.

The memory 120 may also include a waste handling rules module 124 that, when executed, may cause the processor 114 to determine one or more tasks for compliance with waste handling rules and regulations for each of the selected sites. The one or more tasks may include actions or processes to comply with federal, state, or local regulations; actions or processes determined by the particular business; actions or processes required for transportation of the waste items; or any combination thereof.

The memory 120 may include an encryption/decryption module 125 that, when executed, may cause the processor 114 to determine hash values associated with the block chain and to encrypt or decrypt data associated with the block chain, for example, in response to a query. The memory 120 may further include a product identification module 126 that, when executed, may cause the processor 114 to compare product information from one of the mobile units 104 to product data stored in memory 120 and, when the waste item is not identified from the product data, optionally to search one or more data sources 108 (or even communicate with social media sites to solicit information to identify a product) to identify the waste item. Once the waste item is identified, information about the waste product (including, for example, the name, composition, waste category, other information, or any combination thereof) may be communicated to the mobile unit 104 to allow the user to rescan and sort the waste item.

The memory 120 may include a package management module 128 that, when executed, may cause the processor 114 to monitor full packages and to track the loading and unloading of packages associated with a particular mobile unit 104. Further, in some embodiments, the package management module 128 may direct the shipping or further delivery of packages from the mobile unit 104 to a selected destination, such as a waste facility, a shipping company, another vehicle, a particular location, or any combination thereof. Such package information may be received from a mobile unit 104, and the processor 114 may provide unload instructions to the particular mobile unit 104. Other embodiments are also possible.

The memory 120 may include a report generator 130 that, when executed, may cause the processor 114 to generate a report for printing or for electronic transmission to one or more destination devices, such as a destination device associated with one of the one or more waste sites 110. In an example, the report generator 130 may provide compliance information, waste item information, and other information to a computing device at the waste site 110 for compliance reporting and record keeping. Other reports may also be generated.

The memory 120 may further include a communication module 132 that, when executed, may cause the processor 114 to receive data, requests, and other information from waste sites 110, mobile units 104, data sources 108, other sources, or any combination thereof. Further, the communication module 132 may cause the processor 114 to communicate reports, product information, package management instructions, waste handling rules, route management information, other information, or any combination thereof to the mobile units. In some instances, the communication module 132 may cause the processor to communicate report information and other information to the waste sites 110. Other embodiments are also possible.

The memory 120 can also include a block chain module 133 that, when executed, may cause the processor 114 to receive data from one or more mobile units 104 or from waste sites 110, authenticate the data, append the block chain with the received data, and verify the block chain. In some embodiments, the block chain module 133 may cause the processor 114 to communicate with other devices that include databases of block chain data 119 to append the block chain. In this example, the block chain data may be distributed across a plurality of nodes coupled to the network 106, providing fail-over reliability and making it extremely difficult to alter the data. In some embodiments, in response to a data submission and in response to a data request, one or more nodes may authenticate the submission or the request based on a hash value, user identifier, device identifier, or other information prior to appending the block chain or providing the response data. Other embodiments are also possible.

In an example, the waste management system 102 may communicate an ordered list of waste sites to one of the mobile units 104 through the network 106. The mobile unit 104 may include a computing device, a printer, one or more cameras or optical scanners, a scale, a display, and an input interface (such as a keyboard, keypad, mouse, pointer, or any combination thereof). In some instances, the display and the input interface may be combined in the form of a touchscreen interface. In a particular embodiment, the touchscreen interface may be a resistive touchscreen interface, which may be configured to receive user input from a user wearing gloves. In some embodiments, one or more of the cameras or optical scanners, the scale, the display, the input interface, and the printer may be integrated into a single, portable housing. Other embodiments are also possible.

Continuing the example, the mobile unit 104 may provide an interface through which a user may log in and access the computing device. Further, the mobile unit 104 may provide the ordered list of sites to the display. The user may select one of the sites from a list by interacting with the touchscreen or by scanning a barcode, and the mobile unit 104 may present information related to the selected site to the display. The user may scan, weight, and sort various unsaleable items into selected packages. Each package may be a bin or other container that is configured to secure unsaleable items of the same or similar chemical composition, such as flammable toxic materials, flammable aerosols, and so on. The mobile unit 104 may itemize and store information related to each waste item in a record associated with the associated package and may communicate such information to the waste management system 102 through the network 106 (periodically, in real-time, at selected intervals, in response to a command from a user, or any combination thereof). Once a package is full, a content list and label may be printed for the package and a new label may be printed for an empty container. Further, the data associated with each item in the package may be aggregated to form a block of data, which may be appended to the block chain and communicated to each of the nodes coupled to the network 106.

When the mobile unit 104 and the associated packages are at a selected location, the full packages may be unloaded. The unload locations may be sent from the waste management unit 102 or may be pre-determined locations. The touchscreen display may provide instructions and may track the loading and unloading of packages, establishing updated records which may be aggregated and appended to the block chain. The data block may be sent to the waste management system 102 for tracking and management and to append the block chain at each node, including the waste management system 102, the waste sites 110, and other data sources 108.

Subsequently, the resulting data may be printed for inventory and waste item tracking purposes, for a paper-based audit, for reports, or any combination thereof. When the bin is ready for shipment, a manifest may be printed and attached to the bin. Other embodiments are also possible.

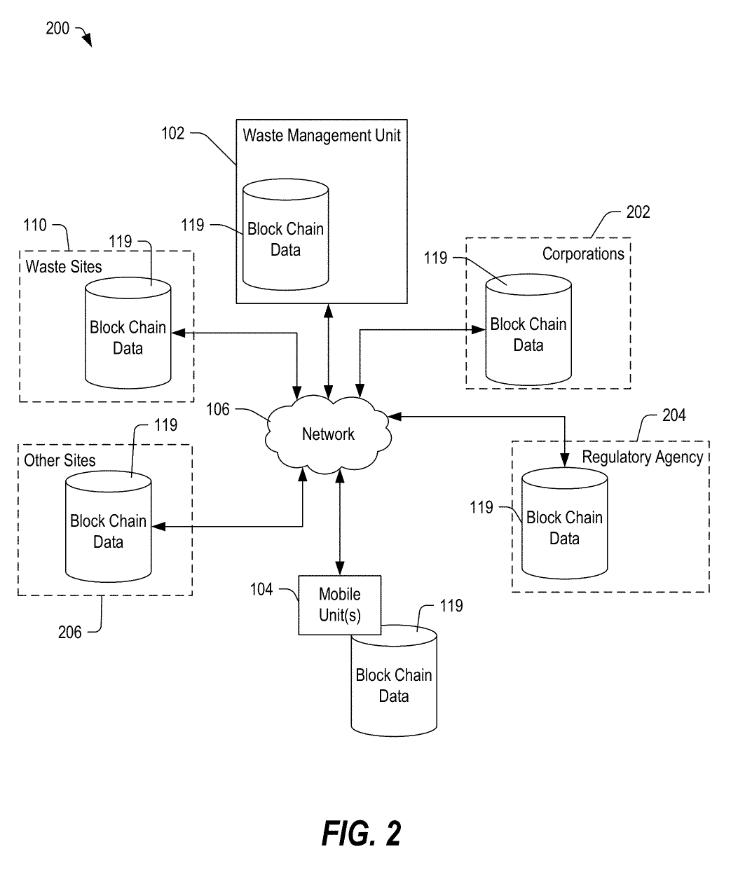

FIG. 2 depicts a block diagram of a system 200 including the elements of FIG. 1 and depicting a distributed block chain of data related to the collection and disposal of unsaleable items, in accordance with certain embodiments of the present disclosure. The system 200 includes the waste management unit 102, one or more mobile units 104, waste sites 110, corporations 202, regulatory agencies 204, other sites 206, or any combination thereof, each of which may include a copy of the block chain data 119. Further, each of the waste management unit 102, one or more mobile units 104, waste sites 110, corporations 202, regulatory agencies 204, and other sites 206 may be configured to communicate with one another through the network 106.

It should be understood that when a change is made to the block chain data at one node, such as the mobile unit 104, the change initiates creation of a new record, which may be aggregated with other records to form a data block (either at the mobile unit 104 or at the waste management unit 102). The data block may then be appended to the block chain and the block chain data 119 at each node can be updated, providing a distributed database of information related to the capture and disposal of unsaleable items.

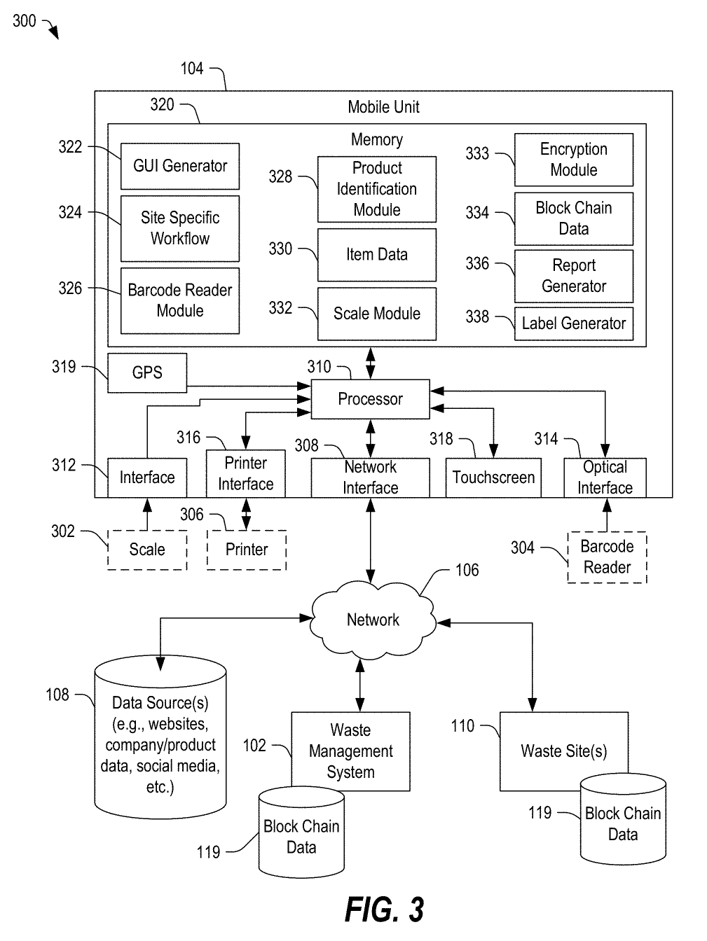

In general, each mobile unit 104 may include one or more optical sensors, such as cameras, barcode scanners, or other optical sensors. Further, each mobile unit 104 may include a processor configured to control operation of the unit 104 and to control operation of the optical sensors, a printer, and other components. One possible embodiment of a mobile unit 104 is described below with respect to FIG. 3.

FIG. 3 depicts a block diagram of a system 300 including a mobile unit 104 configured to capture data corresponding to the collection and disposal of unsaleable items, in accordance with certain embodiments of the present disclosure. The system 300 may be an embodiment of the system 100 of FIG. 1, the system 200 of FIG. 2, or any combination thereof. The mobile unit 104 may be configured to communicate with the waste management system 102, one or more data sources 108, one or more waste sites 110, other mobile units 104, or any combination thereof through the network 106.

The mobile unit 104 may include or may be coupled to a scale 302 configured to determine a weight of a waste item, a printer 306 configured to print labels and reports, and a barcode reader 304. In some embodiments, the barcode reader 304 maybe omitted, and barcode data may be determined from optical data captured by the optical interface 314, which may include a camera.

The mobile unit 104 may include a network interface 308 configured to communicate with the network 106. The mobile unit 104 may also include a processor 310 coupled to the network interface 308. The processor 310 may also be coupled to a scale 302 through an interface 312, to a printer 306 through a printer interface 316, and to a barcode reader 304 through the optical interface 314. In some embodiments, the optical interface 314 may include or be coupled to one or more cameras. Further, in some embodiments, the optical interface 314 may include the barcode reader 304 or may provide barcode reader functionality using an integrated camera or other optical sensor.

The processor 310 may also be coupled to a touchscreen 318. Further, the processor 310 may be coupled to a memory 320 configured to store data and processor-executable instructions. It should be appreciated that the processor 310 may be coupled to the scale 302, the printer 306, and the barcode reader 304 via wireless or wired connections.

The memory 320 may include a graphical user interface (GUI) generator 322 that, when executed, may cause the processor 310 to generate a graphical interface including data, images, and selectable elements accessible by a user to interact with the graphical interface to enter data, to select options, and so on. The memory 320 may further include a site specific workflow module 324 that, when executed, may cause the processor 310 to determine site-specific information, such as tasks, timing information, and other information, and to provide the site-specific information to the touchscreen 318.

The memory 320 may include a barcode reader module 326 that, when executed, may cause the processor 310 to control the optical interface 314 to capture barcode information from a waste item. The memory 320 may further include a product identification module 328 that, when executed, may cause the processor 310 to determine identify a product based on the barcode data received from the optical interface 314. In one example, the product identification module 328 may cause the processor 310 to search item data 330, to search one or more data sources 108, or to communicate with the waste management system 102 to determine product information.

The memory 320 may further include a scale module 332 that, when executed, may determine the weight of the unsaleable item using the scale 302. The processor 310 may store the item information and the weight in the memory 320 as item data 330. The memory 320 may include an encryption module 333 that, when executed, may cause the processor 310 to encrypt data associated with a record associated with an unsaleable item prior to sending the record (or a block of records) to the waste management system 102 (i.e., before posting the record to the block chain). The memory 320 can also include a block chain data module 334 that, when executed, may cause the processor 310 to append a block chain with the record. Other embodiments are also possible.

The memory 320 can also a report generator 336 that, when executed, may cause the processor 310 to generate a report related to the collected waste items and to send the report to the waste management system 102. Such reports can include data related to unidentified unsaleable items, data related to collected unsaleable items, data related to packages storing the collected unsaleable items, data related to the loading or unloading of packages, other data, or any combination thereof. In some embodiments, the report generator 336 may cause the processor 310 to generate a report for sending to a computing device associated with a waste site 110, such as a compliance report, waste item collection information, other information, or any combination thereof.

The memory 320 may further include a label generator 338 that, when executed, may cause the processor 310 to print one or more labels, manifest data, or other data onto a label or sheet of paper using the printer 306. In an example, the label generator 338 may cause the processor 310 to print via the printer 306 a source label to be applied to an unsaleable item source bin at a waste site 110. The label generator 338 may cause the processor 310 to print via the printer 306 a package label to be applied to a package of collected waste items. The label generator 338 may also cause the processor 310 to print via the printer 306 a manifest, a report, other information, or any combination thereof.

In some embodiments, the mobile unit 104 may include a table computer with a touchscreen 318 that is coupled to or that includes one or more optical scanners configured to capture optical data, such as barcode data. The mobile unit 104 may present a graphical user interface to the touchscreen 318, and a user may interact with the graphical interface via the touchscreen 318 to perform tasks associated with a waste site 110, such as collecting unsaleable items. The mobile unit 104 is configured to automatically identify unsaleable items based on the optical data, to capture weight data associated with the unsaleable item, to guide the user to place the unsaleable item in a selected package (or bin), and to update a data record associated with the package to indicate the addition of the identified unsaleable item. The mobile unit 104 is further configured to direct the user to place unidentified unsaleable items aside or in an “unidentified bin” and to instruct the user (via an alert or other indicator within the graphical interface) to rescan the unidentified unsaleable item, once the waste management system 102 has acquired the identification information needed to properly classify the unsaleable item. Other embodiments are also possible.

It should be appreciated that the mobile unit 104 may be implemented as a fully integrated computing device, such as a tablet computer with an integrated scale. The printer 306 may be implemented as a wireless printer that can be configured to communicate with the tablet computer via a short-range wireless communication link, such as a Bluetooth® or other wireless communication link.

In some embodiments, the mobile unit 104 may include a computing device coupled to a movable cart with wheels. One possible example of such a mobile unit 104 is described below with respect to FIG. 3.

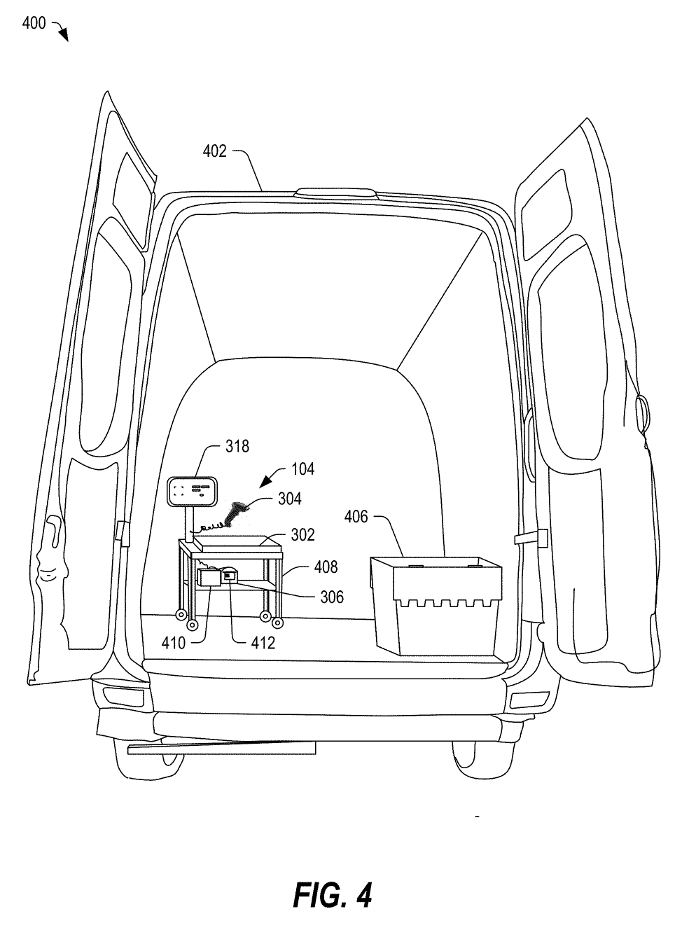

FIG. 4 depicts a system 400 including the mobile unit 104 of FIGS. 1-3, in situ, in accordance with certain embodiments of the present disclosure. The system 400 may be an embodiment of a portion of the systems, 100, 200, and 300 of FIGS. 1-3. The system 400 may include a vehicle 402, such as a van or truck, defining an enclosure sized to receive waste items and to secure the mobile unit 104. The mobile unit 104 may include the touchscreen 318, a barcode reader 304, and a scale 302 coupled to a cart 408. The cart 408 may include wheels to allow the cart 408 to be moved around. The cart 408 may also hold the printer 306 and a power source, such as a battery 410. The enclosure also includes a package 406 or bin of scanned and sorted unsaleable items.

In some embodiments, the operator may place an unsaleable item on the scale 302 and scan a barcode of the unsaleable item using the barcode reader 304. The mobile unit 104 may determine a product category of the unsaleable item based on the barcode data and may provide information related to the scanned item to the touchscreen 318 within a graphical interface. The information may include data indicating a package or bin, such as package 406, into which the unsaleable item should be placed. Multiple packages may be prepared within the back of the vehicle 402 for receiving different categories of waste items. Alternatively, the packages may be picked up from a site in a closed and sealed state, such that the mobile unit 104 may verify the weight of the picked up package and may scan the package manifest.

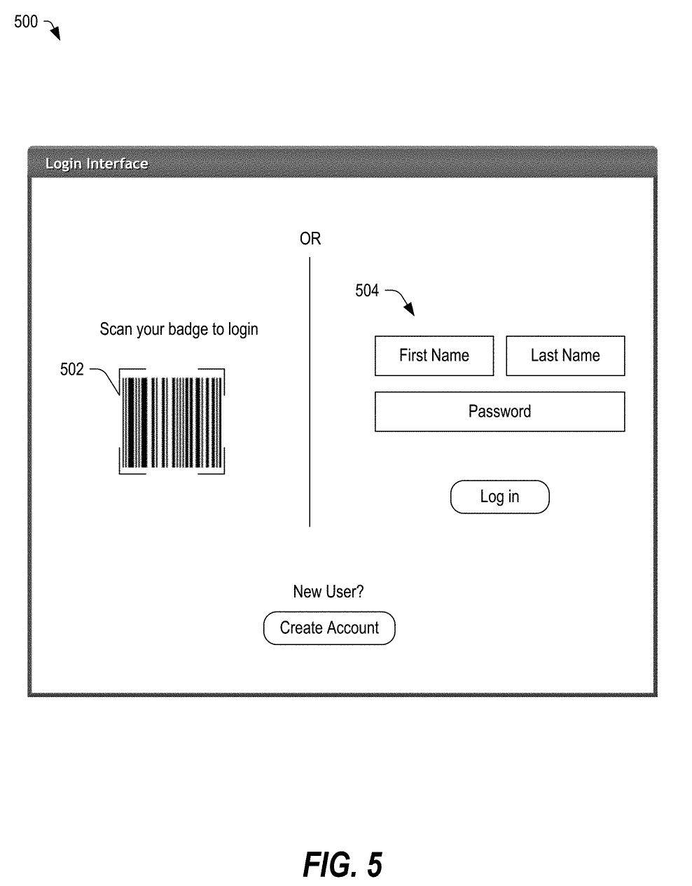

In an example, when a package 406 is full, the user may interact with the graphical interface on the touchscreen 318 to print a package label 412 via the printer 306. The package label 412 may be applied to the package 406, and a new package label may be printed to apply to a new bin or package 406. The touchscreen 318 may be accessed to print other documents, labels, and reports as well. Examples of graphical interfaces presented via the touchscreen 318 are provided below with respect to FIGS. 5-11. It should be appreciated that the following examples of graphical interfaces are provided for illustrative purposes only, and that other graphical interfaces may also be provided. Further, it should be appreciated that the graphical interfaces are provided for illustrative purposes only, and are not intended to be limiting.

FIG. 5 depicts a graphical login interface 500 provided by the mobile unit of FIGS. 1-4, in accordance with certain embodiments of the present disclosure. It should be appreciated that the graphical login interface 500 may be provided on the touchscreen 318, and that a user may login using first name, last name, and password information (and select the “Log in” button) or may use the barcode reader 304 to scan his or her employee badge to log into the system. If the user is new to the system, he or she may select the “Create Account” button to access an account management page through which he or she can configure the user account information. Other embodiments are also possible.

In some embodiments, the mobile unit 104 may have authentication information stored locally to authenticate the user based on the data input. In other embodiments, the mobile unit 104 may send the credential information to the waste management system 102, which may verify the information against stored information to determine if the user should be authenticated. If the login information is valid, the mobile unit 104 may present one or more other graphical interfaces to the touchscreen 318.

It should be understood that each of the graphical interfaces may be part of a single software application executing on the processor 310 of the mobile unit 104. In some embodiments, the graphical interfaces may be independently generated. In other embodiments, the graphical interfaces may be updated versions of the application interface. Other embodiments are also possible.

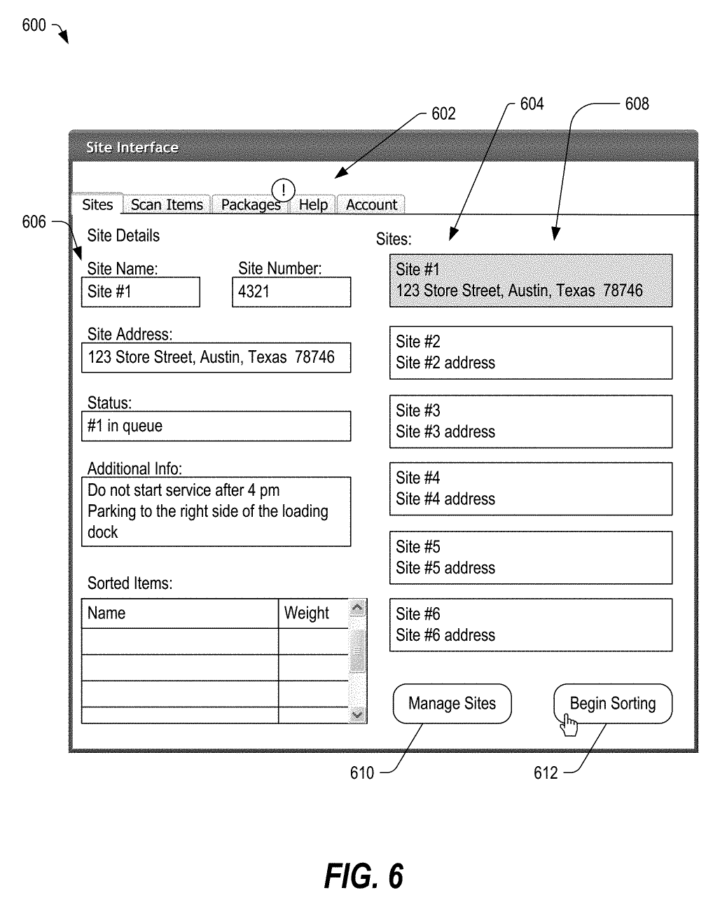

FIG. 6 depicts a graphical site interface 600 provided by the mobile unit 104 of FIGS. 1-4, in accordance with certain embodiments of the present disclosure. The graphical site interface 600 may be presented via the touchscreen 318. In the illustrated example, the graphical site interface 600 may include a plurality of tabs 602, including a “Sites” tab, a “Scan Items” tab, a “Packages” tab, a “Help” tab, and an “Account” tab. In this example, the “Sites” tab is selected. In some instances, the “Sites” tab may be a default tab that can be presented within the graphical interface 600 after a successful login.

The “Sites” tab may include a sites portion 604 and a site details portion 606. The sites portion 604 may include a list 608 of waste sites to be visited. In this example, the first site in the list 608 is selected, causing the site details portion 606 to display data corresponding to the selected first site. It should be understood that a user or operator may select a site by touching the list item on the touchscreen 318.

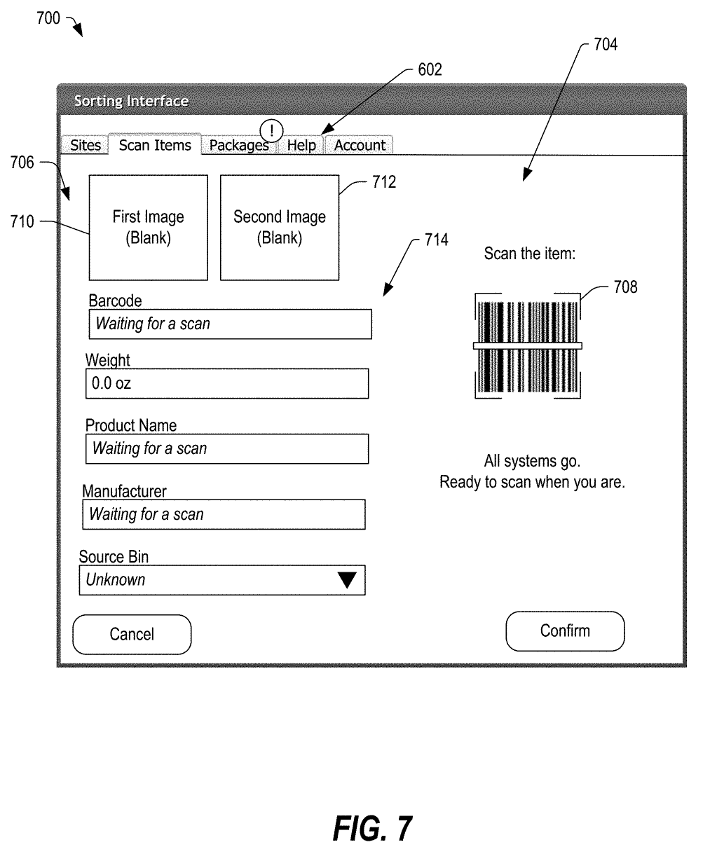

The site details portion 606 includes the site name, the site number (which may be a unique identifier, such as a store number), and an address. Further, the site details portion 606 may include a status, additional information (such as parking instructions, timing information, and other data), and a list of already sorted unsaleable items and their weight. If the user has not yet started sorting unsaleable items, no items will be shown in the sorted items list. If the user wishes to adjust the order of the sites in the list 608 or to otherwise update one or more of the sites, the user may select the “Manage Sites” button 610, which may cause the graphical interface 600 to provide a pop up or other interface for making changes to the site information. If the user is ready to begin sorting unsaleable items, the user may select the “Begin Sorting” button 612, which may cause the mobile unit 104 to present a graphical sorting interface, such as the interface depicted in FIG. 7.

FIG. 7 depicts a graphical sorting interface 700 provided by the mobile unit of FIGS. 1-4, in accordance with certain embodiments of the present disclosure. The graphical sorting interface 700 may be provided by the touchscreen 318 in FIG. 2. In the illustrated example, the “Scan Items” tab is selected.

The “Scan Items” tab includes a first portion 704 including a barcode scan alignment block 708 for assisting the user with scanning the barcode of an unsaleable item. The “Scan Items” tab may further include unsaleable item details, including a first image 710 and a second image 712 of the unsaleable item and a plurality of data fields 714 related to the unsaleable item. In some embodiments, the plurality of data fields 714 can include barcode data, the weight of the unsaleable item, a product name, a manufacturer, a source bin from which the item was removed, other fields, or any combination thereof.

In one possible example, the user may scan a barcode on a source bin using a barcode reader 304, which may cause the mobile unit 104 to update the source bin field with the barcode data or other identifying information. The user may then utilize the barcode reader 304 to scan the unsaleable item. Alternatively, the user may present the unsaleable item to a camera of the mobile unit 104. Upon scanning the barcode or capturing image data including the barcode, the mobile unit 104 also determines the weight of the unsaleable item and attempts to identify the unsaleable item and an associated item category. The graphical interface may then prompt the user to place the unsaleable item in a particular package or bin and may store data corresponding to the unsaleable item and the bin in a memory.

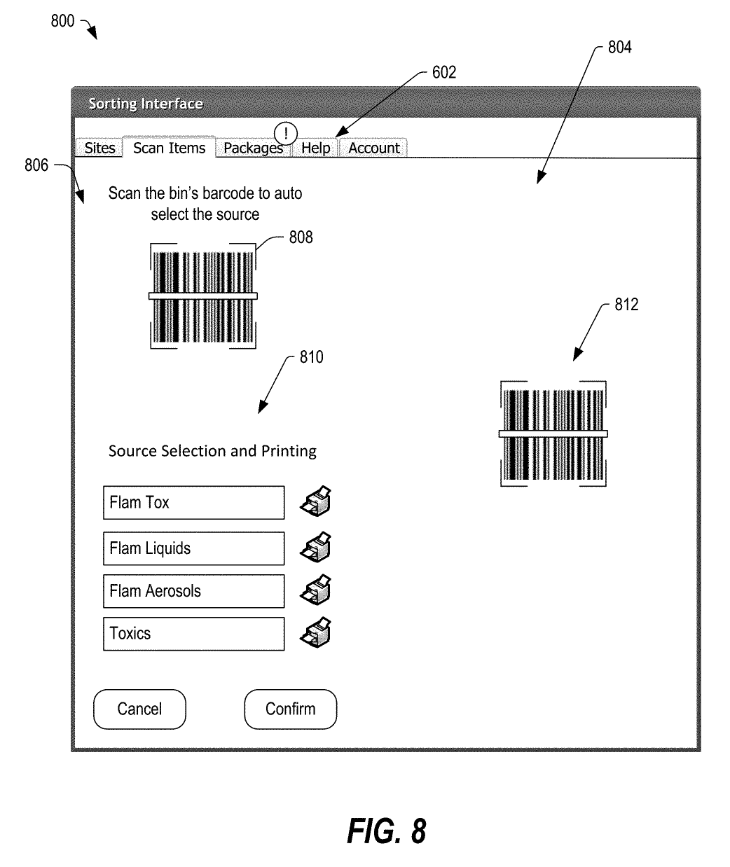

FIG. 8 depicts a graphical sorting interface 800 provided by the mobile unit 104 of FIGS. 1-4 to select and print labels for source bins, in accordance with certain embodiments of the present disclosure. The graphical sorting interface 800 may be provided by the touchscreen 318 in FIG. 3.

In this example, the graphical sorting interface 800 provides a first portion 804 including a barcode alignment feature 812 (which may be used to align the barcode within a view area of a camera. The second portion 806 may include a barcode alignment feature 808 for scanning a source bin and a plurality of selectable elements 810 corresponding to source bin categories for selection and printing of labels. In an example, the user may select one of the bins and print a source bin label, which can be applied to the bin to speed sorting in the future. Other embodiments are also possible.

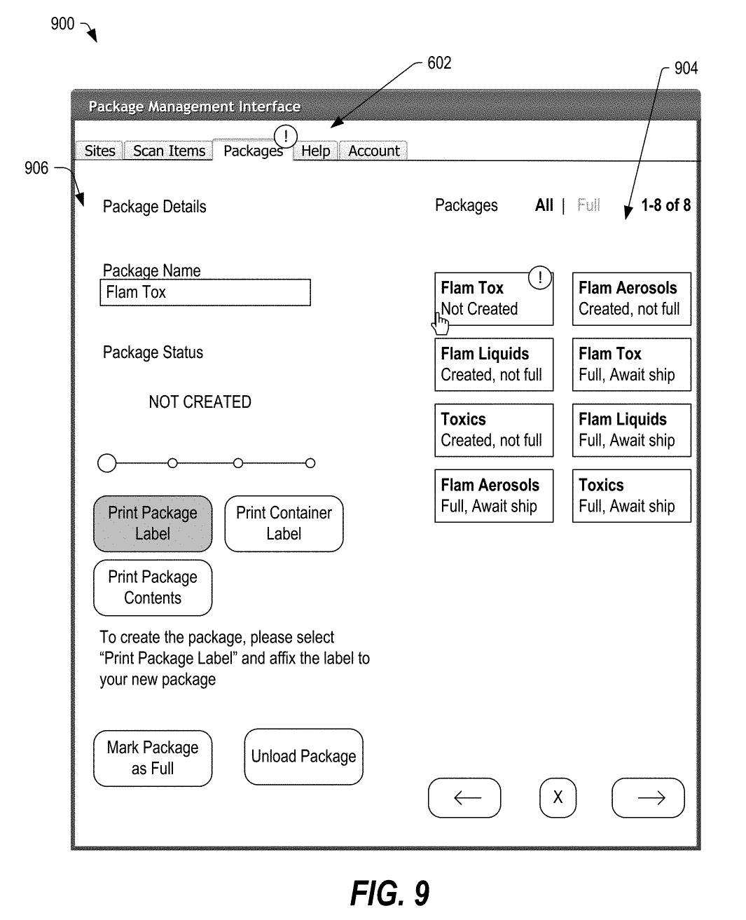

FIG. 9 depicts a graphical package management interface 900 provided by the mobile unit of FIGS. 1-4 to select and print labels and reports, in accordance with certain embodiments of the present disclosure. In this example, the “Packages” tab is selected. It should be noted that the “Package” tab is depicted with an alert indicator superimposed thereon, indicating that a previously scanned item or a previously completed package has an alert attached thereto.

In one example, when an item is scanned and cannot be identified, the mobile unit 104 may communicate information related to the scanned item to the waste management system 102, which may use various tools to identify the item. Once identified, the waste management system 102 may send an alert to the mobile unit 104, requesting that the user now rescan the item. This alert may show up as an alert indicator superimposed on the “Scan Items” tab.

In this example, the alert indicator is showing that the alert is related to the packages. The “Packages” tab includes a first portion 904 including a plurality of selectable elements, including an option to select between “All packages” or “Full packages.” Further, the first portion 904 includes a plurality of user-selectable objects representing the packages, of which there are eight.

In this example, the packages include a “Flam Tox” package that is “not created”; a “Flam Aerosols” package that is “created, not full”; a “Flam Liquids” package that is “created, not full”; a “Flam Tox” package that is “Full, await ship” or “Full, await unload”; a “Toxics” package that is “Created, not full”; a “Flam Liquids” package that is “Full, await ship”; a “Flam Aerosols” package that is “Full, await ship”; and a “Toxics” package that is “Full, await ship”.

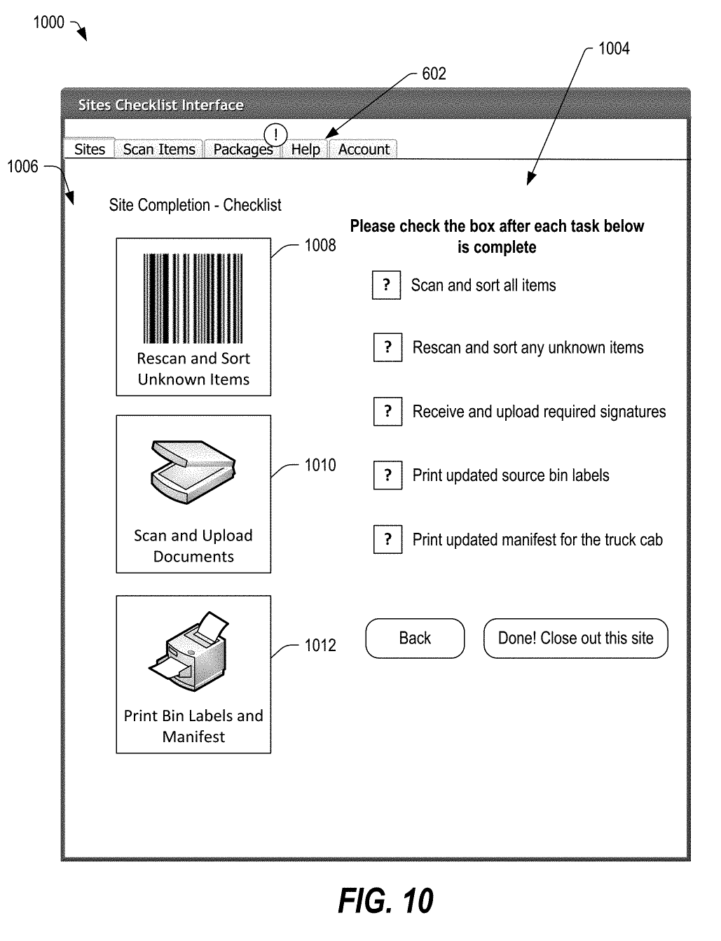

In the illustrated example, the selectable object labeled “Flam Tox” package that is “Not created” is selected, and the graphical package management interface 900 includes a second portion 906 that includes package details, such as the package name. Further, the second portion 906 of the interface 900 includes a progress indicator and user-selectable buttons, including a “Print Package Label” button, a “Print Container Label” button, and a “Print Package Contents” button. Further, the second portion 906 includes a “Mark Package as Full” button and an “Unload Package” button. The user may select these buttons to update the status of a particular package. Other embodiments are also possible. The “Packages” tab also includes a back arrow button, a cancel button, and a forward arrow button. When the user selects the forward arrow button, the interface may present a site completion checklist page, as shown in FIG. 10.

FIG. 10 depicts a graphical site checklist interface 1000 provided by the mobile unit 104 of FIGS. 1-4 to identify tasks to be completed and verified by the operator, in accordance with certain embodiments of the present disclosure. The graphical sorting interface 1000 may be provided by the touchscreen 318 in FIG. 2.

In this example, the site checklist interface 1000 may include a first portion 1004 including a list of tasks to be performed, that the user must check off as being completed. The site checklist interface 1000 may also include a second portion 1006 including a “Rescan and Sort Unknown Items” button 1008, a “Scan and Upload Documents” button 1010, and a “Print Bin Labels and Manifest” button 1012. It should be appreciated that these buttons may illustrative examples of possible interface buttons, but that other functionality in addition to or in lieu of the above functionality may be provided.

In one particular embodiment, certain unsaleable items may need to be documented by signed documentation acquired from employees at a particular site for compliance purposes. In this example, the “Scan and Upload Documents” button may be accessed to scan signed documents and upload them to the system. The mobile unit 104 may prevent completion of the site until all documents are collected and all tasks are completed. Other embodiments are also possible.

If further actions are required, the user may select a “Back” button to return to a previous page. Alternatively, once the user is done with the site, the user may select the “Done! Close out this site” button. Other embodiments are also possible.

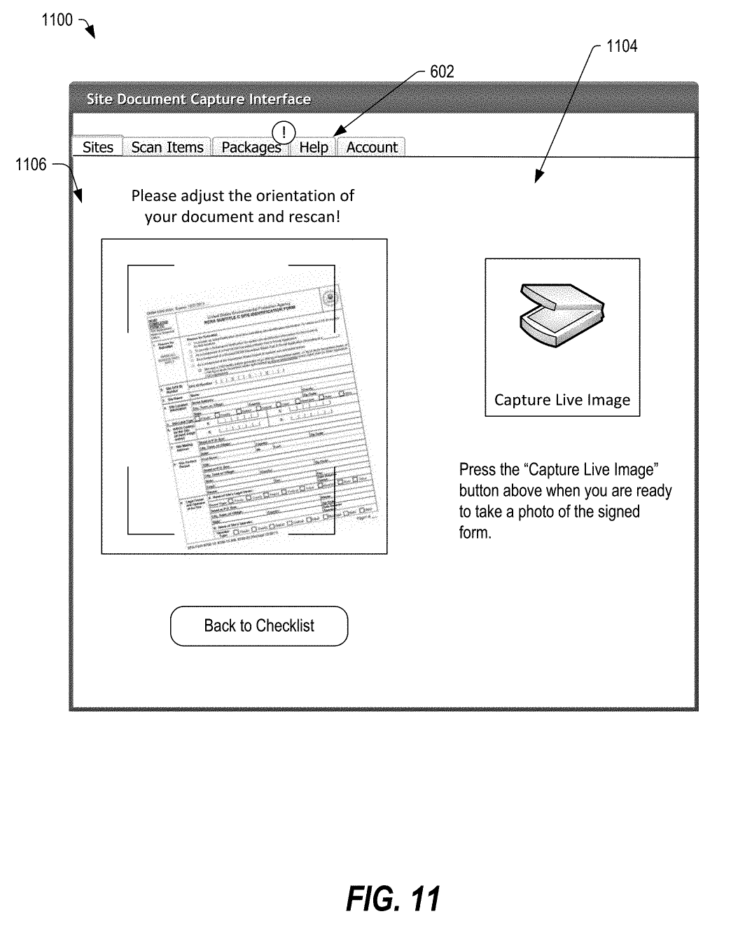

FIG. 11 depicts a graphical document capture interface 1100 provided by the mobile unit 104 of FIGS. 1-4 to allow the operator to scan and upload documents, in accordance with certain embodiments of the present disclosure. In this example, the graphical document capture interface 1100 may provide a first portion 1104 including a capture live image button, and a second portion 1106 depicting the scan of the live image together with instructions to rescan if the alignment is incorrect, for example.

Once the scanned document is received, the user may return to the checklist by selecting the “Back to Checklist” button. In examples where multiple documents are needed, the interface 1100 may provide a list of the documents to be uploaded and may either automatically recognize the scanned document or may require the user to identify the scanned document. The interface may not allow the user to close out a site until all of the required documents are scanned and uploaded.

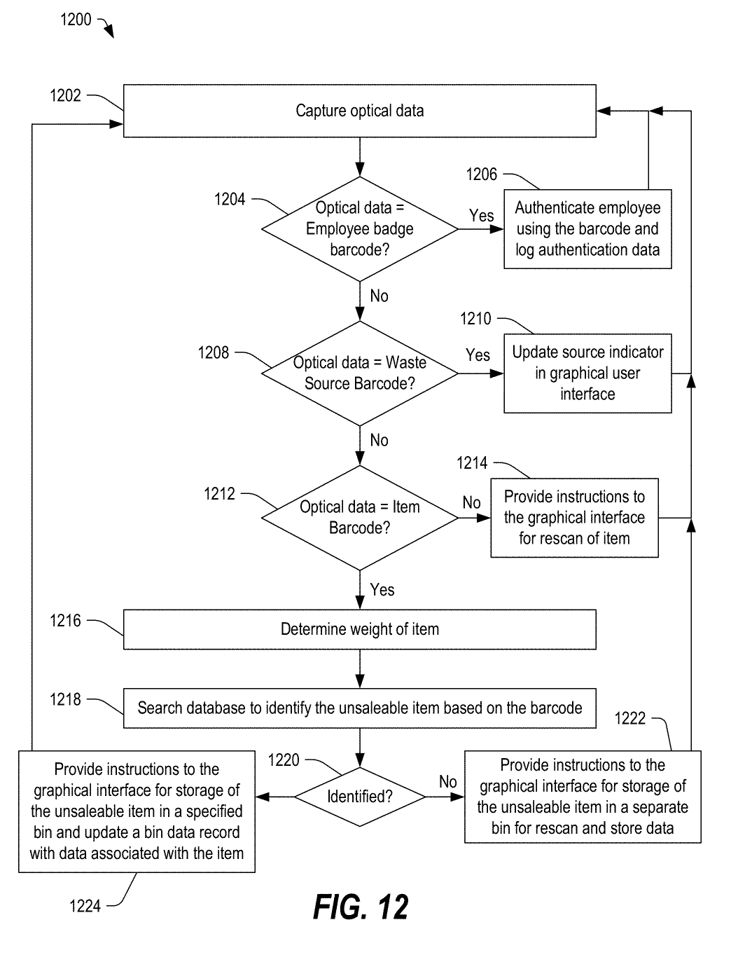

FIG. 12 depicts a method 1200 of capturing waste items, in accordance with certain embodiments of the present disclosure. In this example, the method 1200 may include capturing optical data of a waste item, a bin, a package, an employee badge, or another item, at 1202. The optical data may be captured using a camera, a barcode scanner, another optical sensor, or any combination thereof.

At 1204, if the optical data equals an employee badge barcode, the method 1200 may include authenticating the employee using the barcode and may include logging the authentication data into a memory, at 1206. The method 1200 may then return to 1202 to capture optical data.

At 1204, if the optical data is not equal to an employee badge barcode, the method 1200 may include determining if the optical data is equal to a waste source barcode, at 1208. The waste source barcode may be from a label of a bin from which an unsaleable item is taken to be scanned and sorted. If, at 1208, the optical data is equal to a waste source barcode, the method 1200 may include updating a source indicator in a graphical user interface, at 1210. The method 1200 may then return to 1202 to capture optical data.

If, at 1208, the optical data is not equal to a waste source barcode, the method 1200 may include determining if the optical data is equal to an unsaleable item barcode, at 1212. If not, the method 1200 may include providing instructions to the graphical interface to rescan the item, at 1214. The method 1200 may then return to 1202. In some embodiments, the instructions may instruct the user to rescan the item after all of the other items have been scanned to provide time to identify the unsaleable item from the barcode information.

If, at 1212, the optical data equals the unsaleable item barcode, the method 1200 may include determining the weight of the item, at 1216. The method 1200 may further include searching a database to identify the unsaleable item based on the barcode, at 1218.

At 1220, if the unsaleable item is not identified, the method 1200 may include providing instructions to the graphical interface for storage of the unsaleable item in a separate bin for rescan and may include storing the data. As discussed above, the mobile unit 104 may then communicate the data to a waste management system 102 to identify the item. The method 1200 may then return to 1202 to capture optical data of a next unsaleable item.

At 1220, if the unsaleable item is identified, the method 1200 may include providing instructions to the graphical interface for storage of the unsaleable item in a specified bin and may include updating a bin data record with data associated with the waste item, at 1224. The method 1200 may then return to 1202 to capture optical data of a next unsaleable item.

It should be understood that the waste product identification process represents one possible example of a method of sorting unsaleable items. The order of the steps may be changed without departing from the scope of this disclosure. Further, some of the steps may be combined or steps may be added or omitted, or any combination thereof, without departing from the scope of this disclosure.

It should be appreciated that, in some instances, the handling rules associated with a particular waste site may differ from that of a next waste site, based on the company, based on the local regulations, or based on some other policy or procedure. Accordingly, the mobile unit 104 is configured to manage compliance based on the location where the unsaleable items are collected. While the user may override some of the rules through various interactions with the system, the system may be configured to guide the site and the collection worker to capture, identify, and store items in accordance with best practices.

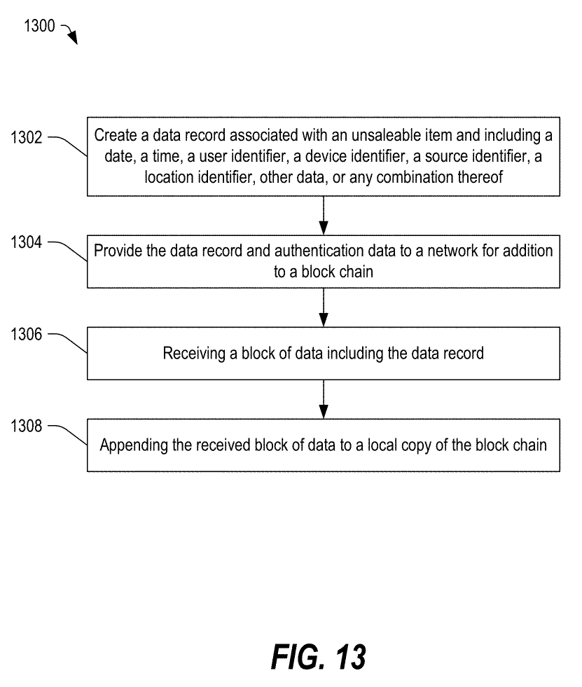

FIG. 13 depicts a flow diagram of a method 1300 of updating a block chain based on captured data associated with an unsaleable item, in accordance with certain embodiments of the present disclosure. At 1302, the method 1300 may include creating a data record associated with an unsaleable item and including a date, a time, a user identifier, a device identifier, a source identifier, a location identifier, other data, or any combination thereof. In some embodiments, an identifier associated with the user and an identifier associated with the computing device may be included in the data record. In some embodiments, the data record may be aggregated with a plurality of other data records to produce a data block.

At 1304, the method 1300 can include providing the data record and authentication data to a network for addition to the block chain. The providing of the data record may be referred to as posting the data record to the block chain. In some embodiments, instead of providing the data record by itself, the method 1300 can include posting a data block to the block chain, where the data block includes a plurality of data records aggregated together. In some embodiments, each data record may include a digital signature that includes the user's name, a device identifier, other information, or any combination thereof. The data block that aggregates multiple data records may include multiple digital signatures or a single digital signature identifying the owner/originator of the data block. Further, the digital signature information may be confirmed by one or more nodes associated with the network to determine the validity of the data record or the data block.

At 1306, the method 1300 can include receiving a block of data including the data record. In an alternative embodiment, instead of receiving the block of data, the method 1300 may include receiving an authentication indicator indicating that the block of data can be appended to the block chain.

At 1308, the method 1300 may include appending the received block of data to the local copy of the block chain. It should be appreciated that the block of data is also appended to the block chain at each node and at each device or system of the network that stores the block chain. Other embodiments are also possible.

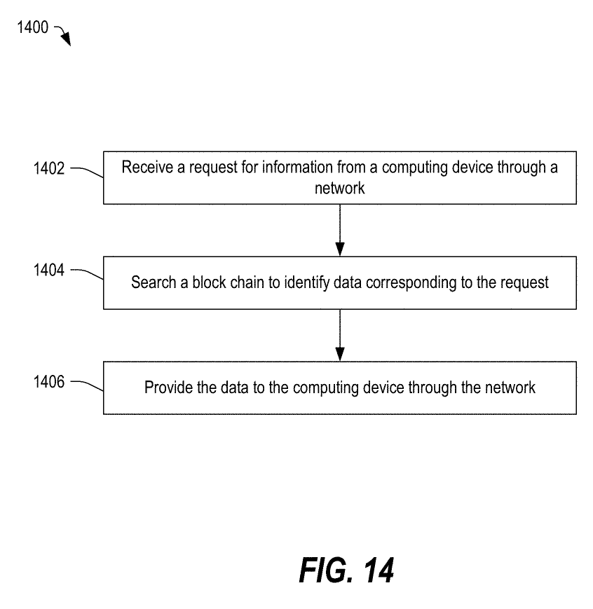

FIG. 14 depicts a flow diagram of a method 1400 of providing data associated with the block chain to a computing device in response to a request, in accordance with certain embodiments of the present disclosure. At 1402, the method 1400 can include receiving a request for information from a computing device through a network. In an example, a user may utilize the computing device to initiate a request to retrieve audit data, which can be recovered from the block chain.

At 1404, the method 1400 can include searching a block chain to identify data corresponding to the request. The search process may include searching a local version of the block chain to retrieve data. At 1406, the method 1400 may include providing the data to the computing device through the network. The retrieved data may be sent as part of a graphical interface or another document to the computing device.

In some embodiments, since the block chain cannot be changed without leaving an audit trail, the block chain may represent data that can be relied upon to provide audit information. Moreover, since the block chain may be updated each time the item is handled (i.e., scanned, moved, handed off, delivered, and so on), the block chain can provide an audit trail. Moreover, any changes (for example, due to mishandling, theft, and so on) will be reflected at a next check point, such that the responsibility (and optionally liability) can be determined.

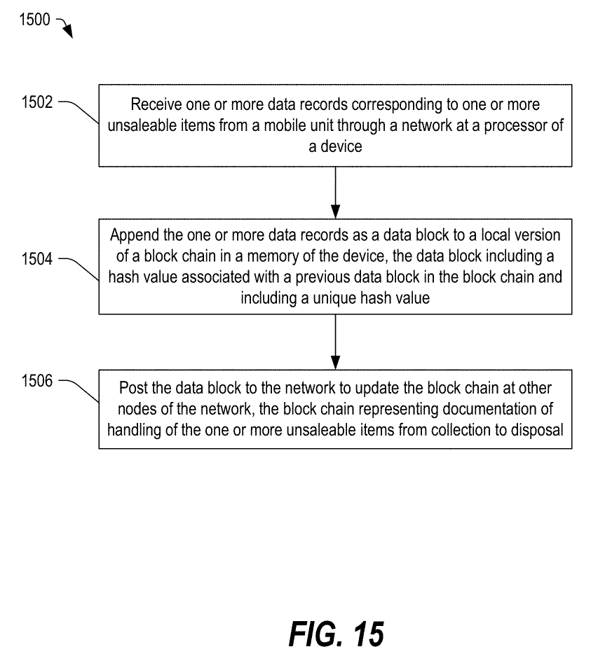

FIG. 15 depicts a flow diagram of a method 1500 of updating a block chain with data records related to unsaleable items, in accordance with certain embodiments of the present disclosure. At 1502, the method 1500 may include receiving one or more data records corresponding to one or more unsaleable items from a mobile unit through the network. In some embodiments, the one or more data records may be received at a processor of a mobile unit 104. In other embodiments, the one or more data records may be received at a waste management system 102 from one or more mobile units 104. Other embodiments are also possible.

At 1504, the method 1500 may include appending the one or more data records as a data block to a local version of a block chain in the memory. In some embodiments, the memory may be a local memory of a mobile unit 104. In other embodiments, the memory may include a database stored at a waste management system 102. Other embodiments are also possible.

At 1506, the method 1500 may include posting the data block to the network to update the block chain at other nodes of the network, where the block chain representing documentation of handling of the one or more unsaleable items from collection to disposal. It should be appreciated that the data may be posted by the mobile unit 104, by the waste management system 102, or by another device, depending on the implementation.

In general, data validity may be determined based on the hash value of the previously posted data block in the block chain, which has to match at each of the nodes. Further, once the data block is posted, each node that stores the block chain is updated as well. Any attempts to change data stored in an earlier block in the block chain may impact the validity of the data in the chain, and such changes can be readily detected by comparing the changed block chain to that stored at other nodes of the network. Accordingly, the sequence of data records of the unsaleable items is rendered tamper proof, making the data chain reliable and verifiable for the capture and disposal of each of the items.

In conjunction with the systems, methods and devices described above with respect to FIGS. 1-15, the systems, methods, and devices may include an apparatus including a network interface coupled to a network. The apparatus may further include at least one optical sensor configured to capture optical data and a processor coupled to the network interface and to the at least one optical sensor. The processor may be configured to receive optical data corresponding to an unsaleable item from the at least one optical sensor, automatically identify the unsaleable item based on the optical data, and automatically create a data record associated with the unsaleable item. The processor may be further configured to communicate the data record to at least one node coupled to the network to update a block chain representing data associated with capture and disposal of the unsaleable item.

Although the present invention has been described with reference to preferred embodiments, workers skilled in the art will recognize that changes may be made in form and detail without departing from the scope of the invention.

What is claimed is:

1. An apparatus comprising:
a network interface coupled to a network;
at least one optical sensor configured to capture optical data; and
a processor coupled to the network interface and to the at least one optical sensor, the processor configured to:
receive optical data corresponding to an unsaleable item from the at least one optical sensor;
automatically identify the unsaleable item based on the optical data;
automatically create a data record associated with the unsaleable item; and
send the data record to at least one node coupled to the network to post the data record to a block chain representing data associated with capture and disposal of the unsaleable item.

2. The apparatus of claim 1, where the at least one optical sensor comprises at least one of a barcode reader and a camera.

3. The apparatus of claim 1, further comprising:
a scale coupled to the processor and configured to weigh the unsaleable item to determine weight data; and
wherein the processor is configured to include the weight data in the data record.

4. The apparatus of claim 1, further comprising a printer coupled to the processor and responsive to the processor to print at least one of a source label for a source bin from which the unsaleable item is received, a package label for a selected bin to which the unsalable item is sorted, a package content list, a truck inventory list, and a shipping manifest.

5. The apparatus of claim 1, wherein:
the at least one optical sensor is configured to capture an image of a document; and
the processor is configured to include the image in the data record.

6. The apparatus of claim 1, further comprising:
a memory coupled to the processor; and
wherein the processor is configured to store the block chain in the memory.

7. The apparatus of claim 1, wherein the block chain is stored at one or more nodes of the network.

8. The apparatus of claim 1, wherein the block chain comprises a plurality of data blocks stored in a sequence, each data block of the plurality of data blocks includes a plurality of data records, at least one of the plurality of data blocks including the data record.

9. A waste management system comprising:
a network interface coupled to a network;
a memory; and
a processor coupled to the memory and to the network interface, the processor configured to:
receive one or more data records corresponding to one or more unsaleable items from a mobile unit through the network;
append the one or more data records as a data block to a local version of a block chain in the memory, the data block including a hash value associated with a previous data block in the block chain and including a unique hash value; and
post the data block to the network to update the block chain at other nodes of the network, the block chain representing documentation of handling of the one or more unsaleable items from collection to disposal.

10. The waste management system of claim 9, wherein the processor is configured to aggregate the one or more data records over time to form the data block.

11. The waste management system of claim 9, wherein the processor is further configured to:
receive a request for information related to the block chain from a computing device via the network;
retrieve data from the block chain that corresponds to the request; and
send the data to the computing device through the network.

12. The waste management system of claim 11, wherein the data is sent to the computing device within a graphical interface.

13. The waste management system of claim 9, wherein the processor is configured to receive data records from a plurality of mobile units including the mobile unit.

14. The waste management system of claim 9, wherein the processor is further configured to receive updated record information from one or more data sources through the network, the updated record information corresponding to handling of each

14. A method of tracking collection and disposal of unsaleable items, the method comprising:
receiving data corresponding to collection of one or more unsaleable items at a processor of a device, the data associated with each of the one or more unsaleable items including optical data, item identification data, date and time data corresponding to collection of collection, an identifier associated with a user, and other data;
generating, using the processor of the device, a block of data including data associated with the one or more unsaleable items, the block of data including a unique hash value and including a hash value of a previous block of data in a block chain; and
posting the block of data to the block chain.

15. The method of claim 14, wherein posting the block of data to the block chain comprises appending the block of data to the block chain stored in a memory of the device.

16. The method of claim 14, wherein posting the block of data to the block chain comprises sending the block of data to one or more nodes of a network via a network transceiver coupled to the processor to update the block chain stored at each of the one or more nodes.

17. The method of claim 14, wherein the data includes location data corresponding to a geophysical location at which each unsaleable item of the one or more unsaleable items was collected.

18. The method of claim 14, further comprising:
receiving updated data corresponding to at least one of the one or more unsaleable items; and
posting the updated data to the block chain as a new block of data.

19. The method of claim 14, further comprising:
receiving, at the processor, updated data corresponding to handling of the one or more unsaleable items from one or more devices through a network; and
posting the updated data as a new block of data to produce an updated block chain.

20. The method of claim 19, wherein the updated block chain includes an audit trail corresponding to the handling of the one or more unsaleable items from the collection to disposal.
